(19) United States
(12) Patent Application Publication
(10) Pub. No.: US 2011/0258235 A1
(43) Pub. Date: Oct. 20, 2011

(54) System for the registration and sale of precious stones and similar commodities

(76) Inventors: Zdenek Stehno, Pardubice (CZ); Stanislav Jakubek, Praha 5 - Zbraslav (CZ)

(21) Appl. No.: 12/803,457

(22) Filed: Jun. 28, 2010

(30) Foreign Application Priority Data
Apr. 16, 2010 (CZ) PV 2010-295

(51) Int. Cl. G06F 17/30

(52) U.S. Cl. 707/802; 707/E17.044

(57) ABSTRACT

This particular solution involves a system for the registration and sale of precious stones and similar commodities whose substance lies in databank (2) listing precious stones, being interactively linked to databank (1) listing the names of stars, while databank (2) of precious stones listing the registered gems (2.1, 2.2 . . . 2.n) is interactively linked to seller's terminal (4) and to customers databank (3), while each precious stone (2.1, 2.2 . . . 2.n) is assigned an appropriate unique name of a star (1.1, 1.2 . . . 1.n) listed in databank (1) containing the names of stars. Each registered precious stone (2.1, 2.2 . . . 2.n) is provided with identification signs in the form of implemented microdots.

### TECHNOLOGY AREA

This invention concerning a system for registering and selling precious stones and similar commodities is designed primarily for dealers in precious stones. At the same time, it enables owners of precious stones to carry out an instant price check, to verify the origin and designation of individual precious stones. It also allows for interactive accessibility of other types of information relating to these commodities.

### CURRENT TECHNOLOGY STATUS

At present, the market of precious stones and similar commodities is oriented both on well-established trading networks as well as on individual customers through direct mail. In case of precious stones, and diamonds in particular, various certificates of origin, weight parameters, purity parameters, photos and other vital identification data necessary for the determination of the price and origin of the commodity are, attached to each item. As a rule, these certificates are attached to this kind of goods on a separate document, which does not guarantee absolute certainty that the attached certificate really belongs to the given product, and there is a degree of likelihood of mistaking appropriate certificate for one belonging to a different product. In such a case, immediate check is time-consuming and this tends to complicate, to a considerable extent, the operation of the market dealing with this particular commodity, and last but not least, it leaves space for dirty business practices.

Therefore, the key purpose of this particular technical solution is to design a system for the sale and registration of precious stones and similar commodities not only allowing for making interactive and instant checks on the actual origin of the goods but also enhancing their marketability by creating a more attractive atmosphere conducive to better sales in this sector.

### SUBSTANCE OF THE INVENTION

The drawbacks mentioned above are eliminated and the underlying purpose of the invention is, to a large extent, accomplished by this system for the registration and sale of precious stones and similar commodities. Its substance lies in a databank of precious stones being interactively linked to a databank listing the names of stars, while the precious stones databank, containing the registered gems, is interactively linked to a dealer's terminal and to a databank of customers. Each precious stone is assigned an appropriate unique name of a star listed in the databank containing the names of stars. As a result, each registered precious stone is provided with identification signs in the form of implemented microdots.

Thanks to this invention, it is possible to ensure accurate registration of precious stones with the advantage of a unique designation of each precious stone by giving it the name of a star, thus enhancing the attractiveness of the sale of this particular commodity. Thanks to this system, accessible both to the seller and to the customer alike, it is possible to make checks on price fluctuations. Last but not least, the system makes it possible to keep accurate track of the movement of a specific commodity and its authenticity.

### OVERVIEW OF PICTURES ON DRAWINGS

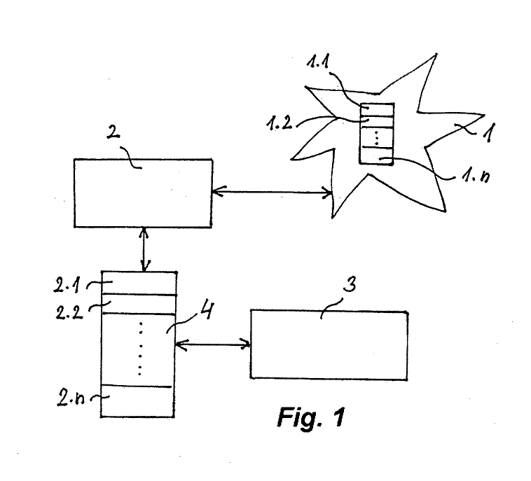

Using a block scheme, FIG. 1 attached thereto gives a graphic example of the basic structural elements of the system and their interconnection.

### EXAMPLE OF THE EXECUTION OF INVENTION

FIG. 1 shows databank 1 listing the names of stars, which can be created, for instance, according to a celestial chart. Interactively linked to this databank is databank 2 listing precious stones, which, in turn, is interactively linked to seller's terminal 4, and to customers access databank 3.

Databank 2 listing precious stones contains the names and data on the registered gems 2.1, 2.2 . . . 2.n, and databank 1 listing the names of stars contains a set of names 1.1, 1.2 . . . 1.n of unique names of stars.

1. The System for the Registration and Sale of Precious Stones and Similar Commodities distinguishing itself by the fact that databank (2) listing precious stones is interactively linked to databank (1) listing the names of stars, while databank (2) listing precious stones and containing the registered precious stones (2.1, 2.2 . . . 2.n) is interactively linked to seller's terminal (4), and to customers databank (3), while each precious stone (2.1, 2.2 . . . 2.n) is assigned an appropriate unique name of a star (1.1, 1.2 . . . 1.n) contained in the databank (1) listing the names of stars.

2. The System for the Registration and Sale of Precious Stones pursuant to Item 1, distinguishing itself by the fact that each registered precious stone (2.1, 2.2 . . . 2.n) is provided with identification signs in the shape of implemented microdots.
